(19) United States
(12) Patent Application Publication
(10) Pub. No.: US 2008/0204765 A1
(43) Pub. Date: Aug. 28, 2008

(54) Method for Contactless Dynamic Detection of the Profile of a Solid Body

(76) Inventors: Manfred Hoffmann, Kassel (DE); Christian Nowaczyk, Kassel (DE); Michael J. Walter, Voerde (DE); Andreas Brinkmann, Dinslaken (DE); Dieter Hoffmann, Hamminkeln (DE)

Correspondence Address: BRINKS HOFER GILSON & LIONE, P.O. BOX 10395, CHICAGO, IL, 60610, US

(21) Appl. No.: 12/067,400

(22) PCT Filed: Sep. 19, 2005
(86) PCT No.: PCT/EP05/54664

§ 371 Date: Mar. 19, 2008

(51) Int. Cl. G01B 11/24

(52) U.S. Cl. 356/606

(57) ABSTRACT

The present invention relates to a method for contactless dynamic detection of the profile of a solid body, particularly a moving one, a laser beam, expanded to form a linear light band, from a laser device being projected onto a region of the surface of the solid body, and the light reflected therefrom being focused in an imaging device, whose optical axis is at a fixed triangulation angle to the projection direction of the laser device and that is arranged at a fixed base distance from the laser device, and is detected by means of a planar light receiving element, in particular at a frequency that is high by compariosn with a speed of movement of the solid body, whereupon signals output by the light receiving element are used in a data processing device as a function of the triangulation angle and the base distance to obtain the measured values of the profile by means of geometric relationships, the values being stored as a profilogram.

### CROSS REFERENCE TO RELATED APPLICATION

This application claims priority to PCT/EP2005/054664, filed Sep. 19, 2005.

### FIELD OF THE INVENTION

The present invention relates to a method for contactless dynamic detection of the profile of a solid body, and particularly a moving body.

### BACKGROUND OF THE INVENTION

It is known that profile detection on solid bodies, that is to say obtaining of profilograms of the surface, can be carried out by means of tactile or contact methods or else in a contactless fashion. Thus, various optical methods of the last type for static detection of solid body profiles are described under the term “topometric 3D metrology” in the reference text authored by Bernd Breuckmann entitled “Bildverarbeitung und optische Meβtechnik” [“Image processing and optical measurement techniques”], Munich: Franzis', 1993, Chapter 6.

A development of laser triangulation is a known method, likewise described in the above reference, in which the laser light beam is expanded to form a linear light band, a so-called light section. DE 103 13 191 A1 describes a method of the type mentioned above in accordance with which particularly for the purpose of determining wear on rail vehicle wheels such light sections are used for contactless dynamic detection of the profile of a solid body, in particular a moving one. A planar detector such as, for example, a video camera, can be used in this case in order to detect the reflected light.

However, the problem arises in practice in the above described reference that the movement of the surface to be measured and the curvature that may be present cause distortions that must be counteracted by a measured value correction since measured values corresponding to reality cannot otherwise be obtained.

The detection instant of the measured values also plays an important role in this case, since selecting this instant wrongly results in measured values that are no longer accessible even after a correction. Thus, a specific type of determination of this detection instant is provided in accordance with DE 103 13 191 A1. The profilogram of a rolling solid body is obtained from three component profilograms determined simultaneously from the two end faces and on the peripheral face of the body. In accordance with that reference, the detection instant of the individual component profilograms being selected in such a way that a measured value determined at this detection instant assumes a maximum from at least three measured values that lie on a circular arc with a radius in one of the end faces, are respectively determined at successive instants and in a unidirectional fashion from the respective lengths of the linear light band, and in each case correspond to half the length of a chord through the circular arc.

It is the object of the present invention to create a contactless method for dynamic detection of the profile of a solid body of the type described above which permits short measuring times and ensures a high measuring accuracy in rugged operating conditions, but at the same time is distinguished by a simplified determination of an optimum detection instant of the measured values and a high level of performance.

### SUMMARY OF THE INVENTION

According to the present invention, the above object is achieved by a method such that initial conditions of the solid body, in particular a distance from the laser device, a temporal variation in this distance and/or a light intensity distribution are/is determined at an initial instant, and thereafter there is determined from the initial conditions a detection instant for which signals output by the light receiving element are selected in order to obtain the measured values of the profile.

Thus, according to the invention faster detection of measured values is achieved because the determination of the detection instant from the initial conditions means there is no longer any need, as in the known way, for three basic steps, specifically; recording three sets of measured values, comparing the measured values, selecting the maximum value. Instead, in accordance with this invention only two steps are required, specifically detecting the initial conditions, only a single set of measured values now requiring to be recorded, and determining the detection instant.

In terms of equipment, this method is associated with the advantage of a possible reduction in hardware requirements, because in the event of a speed of translational movement of the solid body of less than 3.5 m/s there is no need to use a high speed camera, or else in the event of use of a high speed camera it is possible to measure at a very high speed of translational movement of the solid body. Thus, it becomes possible according to the invention to undertake to determine the profile of a solid body, for example rail vehicle wheels of an express train driving at maximum speed. Moreover, only one expanded light band is already sufficient for an accurate measurement, and so in addition to the reduced outlay for hardware there is also a substantial reduction in the time for setting up and calibrating the measuring apparatus.

The determination of the detection instant from the initial conditions can be undertaken in this case, in particular, by means of a digital signal processor (DSP) that can be integrated in the existing data processing device.

Further advantageous designs of the invention are included in the subclaims and in the following detailed description.

### BRIEF DESCRIPTION OF THE DRAWINGS

An exemplary embodiment illustrated by the accompanying drawing is used to explain the invention in more detail. In the drawing,

FIG. 1 shows an illustration of the basic principle of the inventive method of this invention in a schematic side view,

FIG. 2 shows further illustration of the principle of this invention for the purpose of illustrating the fundamentals for the inventive method, in a schematic perspective view,

FIG. 3 shows a program flowchart for the application of the inventive method, and

FIG. 4 shows a perspective view of a wear test stand for wheels of a rail vehicle such as railroad wheels, the inventive method being applied.

### DETAILED DESCRIPTION OF THE INVENTION

Identical parts in the various figures of the drawing are always provided with the same reference symbols, and so they are generally also described only once in each case.

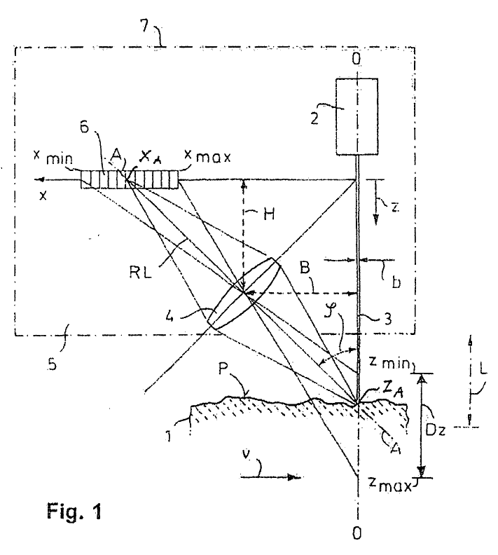

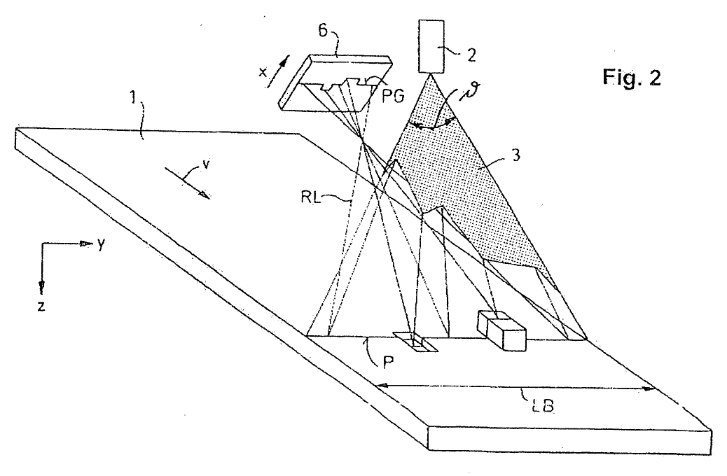

As is firstly shown in FIG. 1 in a two-dimensional illustration with regard to the measurement object, a solid body 1 moving at the speed v, in accordance with the principle on which the inventive method is based a light beam emanating from a laser device 2 is focused by means of optics (not illustrated) such that the width b of the beam lies in a prescribed range in a measuring range Dz that results from the difference between a maximum measurable value zₘₐₓ and a minimum measurable value zₘᵢₙ of the depth or of the profile height z. The light beam is expanded in this case to form a light band 3 as shown by FIG. 2 in a three-dimensional illustration.

Formed by diffuse light scattering (reflected light RL) at the location of impingement z_{A} of the light band 3 on the surface of the solid body 1 is a measuring spot that can also be perceived from directions that deviate from the incidence direction determined by the optical axis O-O of the laser device 2.

If the measuring spot is now imaged onto a planar light receiving element 6 by a corresponding focusing lens 4 of an imaging device at the triangulation angle φ, a position x_{A} of the image spot on the light receiving element 6 is set up depending on the distance of the location of impingement z_{A} between a minimum value xₘᵢₙ and a maximum value xₘₐₓ.

The geometry of the setup of the device used for the inventive method is determined in this case, alongside the permanently set triangulation angle φ, by a fixed base distance B of the optical axis A-A of the focusing optics 4 of the imaging device 5 in relation to the position of the laser device 2, defined by the latter's optical axis O-O. The base distance B can in this case lie preferably in the range of 30 mm to 450 mm, in particular in the range of 60 mm to 270 mm.

By applying trigonometric relationships, the measured image spot position x_{A} can be used to determine the distance of the location of impingement z_{A}, that is to say the distance of the surface of the solid body 1 from the laser device 2, in accordance with the equation

z_{A}=H/(1−B/x_{A}) (1),

H being a distance of the focusing lens 4 of the imaging device 5 from the light receiving element 6 thereof, as illustrated in FIG. 1.

The relative measuring accuracy dz_{A}/z_{A} is yielded in this case as

dz_{A}/z_{A}=1/(1−x_{A}/B)*dx_{A}/x_{A} (2),

the relative resolution dx_{A}/x_{A} of the image spot position depending on the speed v of the solid body in relation to a frequency f at which the reflected light RL is received by the image pickup element 6, and of the signal noise and the type of light receiving element 6. The variable dz_{A} in equation (2) in this case represents an absolute value of the measuring accuracy.

In order to increase the resolution, the final measured values z_{B} of the profile (denoted by P in FIGS. 1 and 2) can be obtained by combining the values z_{A} with correction values Kv, determined in accordance with the speed of movement v of the solid body 1 which are, in particular, vectorial factors and/or summands proportional to the speed of movement v. Here, a correlative combination of the speed of movement v with the frequency f of the detection of the reflected light RL is performed in order to determine the correction values Kv determined in accordance with the speed of movement v.

By varying the above described geometry, in particular the base distance B, the triangulation angle φ and/or a mean working distance (illustrated by the length L in FIG. 1) of the imaging device 5 or the laser device 2 from the region of the surface of the solid body 1 onto which the light band 3 is projected, it is advantageously possible to set the measuring range Dz, and dissociation therewith the measuring accuracy dz_{A}/z_{A} freely simply by the appropriate selection of the geometric variables of the setup. The individual devices need not necessarily in this case, as illustrated in FIG. 1, be enclosed by a common housing 7. An enlargement of the measuring range Dz has the effect in this case of reducing the measuring accuracy, and vice versa. The mean working distance L can preferably lie here in the range of 20 mm to 650 mm, in particular in the range of 150 mm to 350 mm.

According to the invention it is not necessary to use a high speed camera as light receiving element 6 in the design illustrated, but rather, a camera with an image recording frequency of very much less than approximately 60 images/s suffices for speeds of movement (v) up to approximately 4 m/s. Since the resolution depends on the size of the measuring range, that is to say on the measuring range Dz, the significance of this for the dimensioning of an apparatus for carrying out the inventive method is that the number of the detecting camera heads is directly dependent on the required or selected resolution.

As illustrated in FIG. 2, the system so far regarded as only two dimensional will be regarded in three dimensions in order to record the topography of a three-dimensional solid body 1. That is to say, work will be carried out using a laser beam widened to form a light band 3 or sheet of light. The term light-section method is used. After the reflected light RL has been detected by the planar light receiving element 6, and the data processing device (not illustrated), such as a PC, the measured values of the profile P are determined from signals output by the light receiving element 6 and by taking account of the triangulation angle φ and the base distance B, and the measured values are stored in the data processing system as profilogram PG. Such a profilogram PG is represented in the schematic illustration of FIG. 2 by the correspondingly designated polyline on the light receiving element 6.

In one example of the present invention, a commercially available linear laser for example of designation L200 with a line length LB (FIG. 2) of 300 mm and a line width b (FIG. 1) of 1.5 mm was used as laser device 2 projecting light bands 3 onto the surface of the solid body 1.

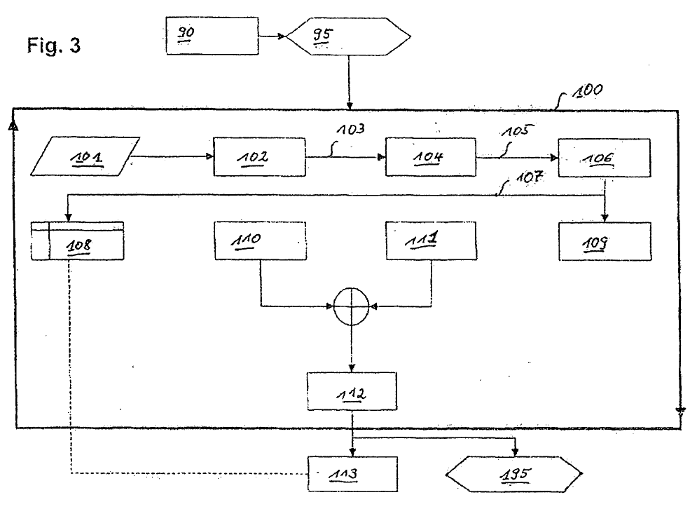

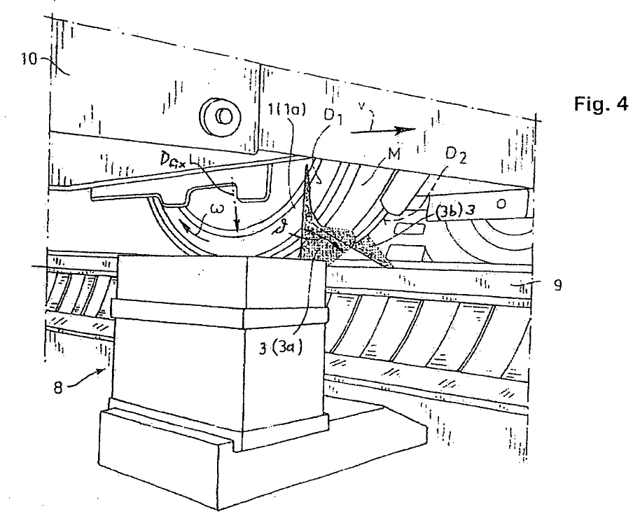

The program flowchart illustrated in FIG. 3 for applying the inventive method is tailored, in particular, to the contactless detection of the profile of wheels of a rail vehicle, such as railroad wheels. Such a wheel, provided with the reference symbol 1a, is illustrated by the example on a rail vehicle 10 in FIG. 4.

The program flowchart comprises, in particular, a receiving loop 100 for dynamic detection of the profile P of the solid body 1 or 1a, which after a request 90 from a server is sot in motion after the system start processes, which are symbolized in FIG. 3 by the box marked with the reference symbol 95, and which comprise the actuation of traffic lights for the rail vehicle 10, the activation of a trigger for image triggering in the light receiving element 6 and the switching on of the laser device 2.

A laser distance sensor 101, which is, in particular, the light receiving element 6, is used in the receiving loop 100 after signal conditioning 102 with the particular purpose of providing a distance signal 103, that is to say at an initial instant t₀ a determination is made of the initial conditions of the solid body 1, 1a, such as the distance from the laser device 2, a light intensity distribution and, if appropriate, a temporal variation in this distance as first and, in the event of accelerated movement, also as second derivative of the path with respect to time.

In the method step of “signal evaluation” 104, the initial conditions—in particular the distance signal 103—are then used to determine a detection instant t_{flash} for which signals output from the light receiving element 6 are selected for the, purpose of obtaining the measured values z_{B} of the profile P. In detail, this means that a triggering pulse 105 is output to the light receiving element 6, for example to a camera, as a result of which image triggering 106 is performed at the detection instant t_{flash}. The detection instant t_{flash} determined from the initial conditions should in this case be determined with the aid of the criterion of greatest possible temporal proximity to the initial instant t₀, since the signals present at the initial instant t₀ and at the detection instant t_{flash} differ from one another in this case only slightly in an advantageous way for the signal evaluation, in this case.

The determination of the detection instant t_{flash} from the initial conditions (distance signal 103) can be undertaken here, in particular, by means of a digital signal processor (DSP) that can preferably be integrated in an existing data processing device. In some circumstances this necessitates connecting an analog-to-digital converter upstream if the laser distance sensor 101 does not supply a digital signal.

Owing to its accurate predictability and extremely short time required for executing the desired operations, a digital signal processor (DSP) is predestined, in particular, for realtime, that is to say continuous, processing of the signals. Its use for the signal evaluation 104 advantageously permits optimum processing of the data present in the form of digital signals, both with regard to data manipulation such as data movement, storage and/or value testing, and with regard to mathematical calculations such as addition and multiplication. Thus, as to the mathematical calculations, it is possible in the signal evaluation 104 to undertake filtering, folding and Fourier, Laplace and/or z transformations in the range of milliseconds. As to the data manipulation, a highly efficient data compression is possible by means of a DSP before data storage or long distance data transmission likewise in the range of milliseconds.

By using a DSP, it is also possible for the temporal variation in the distance of the solid body 1, 1a from the laser device 2, that is to say, for example, the speed of individual subregions of the solid body 1, 1a that are particularly relevant to dynamic profile detection which can preferably be used to determine the detection instant t_{flash} to be determined from the initial conditions if this speed is not detected by direct determination as belonging to the initial conditions, or is permanently prescribed or set.

) For the purpose of quick signal processing, and thus temporal proximity between initial instant t₀, and the detection instant t_{flash}, it is favorable when to determine the initial conditions of the solid body 1, 1a at the initial instant t₀ the signals output by the light receiving element 6 are used in order to obtain a pattern, in particular a binary coded mask, and the detection instant t_{flash} is preferably fixed with the aid of the criterion of the presence, that is to say of a recognition, of this pattern.

In order to obtain and recognize the pattern, it is advantageously possible in this case that a light intensity distribution, in particular in the form of a transparency distribution, present on the solid body 1, 1a at the initial instant t₀ and/or at the detection instant t_{flash} is detected in a histogram and, preferably use of a lookup table (LUT), subjected to an image, transformation, in particular a threshold value operation such as highpass filtering preferably undertaken by means of Laplace transformation. Here, a lookup table (LUT) is understood, as customary in image processing, as an associatively connected structure of index numbers of a field with output values. The so-called color map or palette is an example of a known LUT. It is used to assign color and intensity values to a limited number of color indices usually 256. Within the scope of the invention, it is possible, in particular, for detected and/or then transformed lookup tables to be adapted dynamically to the initial conditions at the corresponding instant t₀. Such signal processing can therefore cope optimally with randomly varying or regularly present environmental conditions such as, for example, variation in lighting conditions owing to indoor light, position of the sun or seasonal influences such as snow, in the event of outdoor considerations.

An alpha channel, preferably a binary alpha channel, can, in particular, be used in order to obtain and recognize the pattern, in particular the binary coded mask. An alpha channel (α channel) is to be understood here, in digital images in the context of imaging and processing, a channel that is present in addition to the three color channels normally used and which also stores the transparency of the individual pixels in addition to the color information coded in a color space. By way of example, it is possible for this purpose to provide one byte per pixel, the result being, as mentioned, 2⁸=256 possible levels for the light intensity. A binary alpha channel is a minimized alpha channel that is based on the use of only one bit per coding of the transparency, and therefore can specify only whether a pixel is either completely transparent (black) or completely opaque (white).

In and alongside and/or as a complement or an alternative to the mode of procedure previously described by way of example, it is possible for the purpose of extracting and recognizing a recognition pattern to make use of others of the methods usually subsumed under the name of “intelligent image processing”, in particular filter operations such as so-called sharpening of an image or the production of a chrome effect.

When the image triggering 106 is performed at the detection instant t_{flash}, an image matrix 107, in particular, is detected, particularly as first complete image after the triggering pulse 105, and the acquired image is fed to a storage means 108. The resetting 109 of a timer is performed simultaneously in this case. As indicated by the receiving loop 100, the operations described are run repeatedly.

The condition checks indicated by the boxes denoted with the reference symbols 110 and 111 serve as abort criteria for the processes in the receiving loop 100. A check (box 110) is made in this case as to whether the timer has already been running more than 10 s, on the one hand, and as to whether all axles of the rail vehicle 10 have been recorded (box 111). The imaging is stopped (box 112) if one of these conditions applies. The question as to whether the timer has already been running more than 10 s is intended in this case to establish whether the solid body 1 or 1a may have come to a standstill. After the stopping 112 of imaging, the stored image data 108 are sent (box 113) to the server. It is possible at the same time to perform the system stop operations of “switch off trigger”, “switch off laser device 2” and “drive traffic lights for the rail vehicle 10”, which are symbolized by the boxes marked with the reference symbol 195.

FIG. 4 shows a typical application of the inventive method, specifically for determining wear. The illustration shows a perspective view of a wear test stand 8 that is conceived for solid bodies 1, measured in the form of wheels 1a which roll on rails 9 and pass by with a translational speed v and an angular speed ω. In order to implement the operations illustrated in the program sequence according to FIG. 3, in particular of the receiving loop 100, it is possible here to incorporate the appropriate hardware in the test stand 8, it advantageously being possible thereby to implement a client-server circuit in which the client is located at the track 9 and the server at a spatially remote location.

It may be seen from the graphic illustration in FIG. 4 that this wear test stand 8 is provided with two profilograms PG as component profilograms of regions lying on the surface of the solid body 1. To this end, two light bands 3a, 3b are projected, and the respective profiles P are determined in accordance with the invention by means of the imaging devices 5 assigned to the light bands.

However, it must be stressed that, as already mentioned, even only one expanded light band, for example the light band denoted with the reference symbol 3a, or else the light band 3b, is sufficient for an accurate measurement.

The wheel 1a of the rail vehicle 10 constitutes a rotationally symmetrical solid body 1 whose basic shape is fundamentally cylindrical or annular, the regions onto which the light bands 3a, 3b are projected lying on the two end faces D₁, D₂ and on the peripheral face M of the cylinder or the annulus.

The respective light band 3a, 3b can be expanded in this case by using a cylindrical optics in such a way that, as illustrated, in each case more than only one of the various sides D₁, D₂, M of the surface of the solid body 1 are illuminated by a light band 3, 3b given appropriate positioning, distance B, of the laser device 2.

Thus, in the case illustrated, the light band 3a illuminates in particular the front end face D₁ and the peripheral face M of the wheel 1a, and the light band 3b illuminates in particular the rear end face D₂ and the peripheral face M of the wheel 1a. Through a high image resolution, for example pixel density, in the light receiving element 6, account is taken in this case of the strong beam expansion in the sense of equation (2) classified above, and thus the required measuring accuracy is ensured even given a large divergence angle of the light band 3a, 3b, for example a divergent angle δ of more than 45°, preferably of more than 60°, for the profile P respectively determined.

The advantage of the use of two light bands 3a, 3b consists here in the following: owing to the fact that the initial conditions 103 of the solid body 1, 1a are determined according to the invention at an initial instant t₀, and that thereafter there is determined from the initial conditions 103 the detection instant t_{flash} for which the signals output from the light receiving element 6 are selected in order to obtain the measured values z_{B} of the profile P, it is possible to project the light bands 3a, 3b onto one and the same measured location with reference to a position on the peripheral face M by means of the laser device(s) 2, simultaneously or else with a time offset. This, in turn, renders it possible for regions of the various sides D₁, D₂, M of the surface of the solid body 1 that are not detected owing to shading as a consequence of a preferably lateral illumination by the light bands 3a, 3b because of shading by a light band 3a, 3b, to be accessible to detection by the respective other light band 3b, 3a given appropriate positioning of the laser devices 2 relative to one another. The component profilogram PG determined in such a way can then be stored in the data processing device, and overall profilogram can be contained therefrom by superposition.

As FIG. 4 shows, the two light bands 3a, 3b do not lie in a projection plane for the purpose of determining the overall profilogram. Neither is it necessary for the light bands 3a, 3b to run parallel to the axle of the wheel 1a. A corresponding deviation from the axial parallelism, such as the illustrated secant-like profile of the light bands 3a, 3b with reference to the end faces D₁, D₂ of the wheel 1a can be compensated by virtue of the fact that the measured values z_{B} of the profile P are obtained by combination with correction values Ko determined in accordance with the region of the surface of the solid body 1, 1a. These correction values Ko can be, in particular, factors and/or summands determined or established in accordance with the region of the surface of the solid body 1, 1a.

A determined profilogram PG such as the component profilograms determined in the above case and the overall profilogram, as well as, if appropriate, a respective reference profilogram and/or the respective deviations, representing wear values, in particular, between the determined profilogram PG and the reference profilogram can advantageously be referred to a permanent basic geometric variable of long term invariability such as a nonwearing wheel rim inside diameter D_{fix}. The nonwearing wheel rim inside diameter D_{fix} can, on the one hand, serve as base line for the measured values z_{B} of the profile height that are determined on the peripheral face M of the wheel 1a, while on the other hand it can also be used to determine correction values Ko that are taken into account in accordance with the region, illuminated by the light band 3 or 3a, 3b, of the surface of the solid body 1.

There are various possibilities known per se for determining such a wheel rim inside diameter D_{fix}. Thus, the wheel rim inside diameter D_{fix} can be determined, for example, from three measured values that are undertaken by contactless dynamic measurements at the moving wheel 1a in the same way, but particularly in one direction, that is to say with the same alignment of the respective light bands 3a, 3b, as the detection of the profilogram PG. The measured values can in this case be three measured values lying on a circular arc with the wheel rim inside diameter D_{fix} being sought, which are determined as ordinate values in a Cartesian coordinate system and are transformed in such a way that they respectively represent half a length of a chord through the circular arc. The nonwearing wheel rim inside diameter D_{fix} of the rolling wheel 1a can then be determined by solving a system of equations that includes the respective transformed ordinate values, the associated abscissa values and the wheel rim inside diameter D_{fix}.

However, it is also advantageously possible to make use as basis geometric variable of long term invariability of a nonwearing wheel rim inside diameter D_{fix} that, if present, originates from a technical drawing of the solid body 1, or from an earlier, for example stored, measurement.

The inventive method advantageously permits the detection of a profile in an extraordinarily short determination time. Thus, the laser devices 2 and imaging devices 5 arranged on both sides of the rails 9 on which the rail vehicle 10 is rolling past can be used to create a respective three-dimensional profilogram for example for five bogeys, that is to say ten wheel sets, in real time operation that is immediately available for further processing. For such a determined profilogram PG, a resolution dz_{A} of less than 2.0 mm, particularly a resolution of less than 0.2 mm, can be achieved in this case.

The present invention is not limited to the illustrated exemplary embodiment, in particular not to the use of a DSP for signal evaluation 104 or signal processing, but rather covers all means and measures that have the same effect in the context of the invention. Furthermore, the person skilled in the art can supplement the invention by additional advantageous measures, for example the addition of processing processes for the solid body 1 that are based on the determined profilograms PG, without departing from the scope of the invention.

With reference to FIG. 4, from which, for example, it is possible to gather the size relationships of the above named test stand 8 in relation to a rail vehicle wheel 1a, it may be stated that a test stand 8 that is designed for the use of the inventive method can be of a very much smaller and more compact overall size than that illustrated, for example approximately twice the size of a shoebox. Consequently, it is advantageously possible in most cases to dispense with complex concrete work when implementing the test stand 8 in a track installation.

While the above description constitutes the preferred embodiment of the present invention, it will be appreciated that the invention is susceptible to modification, variation and change without departing from the proper scope and fair meaning of the accompanying claims.

1. A method for contactless dynamic detection of the profile (P) of a solid body (1, 1a), including a moving one, comprising a laser beam, expanding the beam to form a linear light band (3, 3a, 3b, 3c, 3c1, 3c2, 3c3), projecting the light band onto a region of the surface of the solid body (1, 1a), the light (RL) reflected from the surface being focused in an imaging device (5) whose optical axis (A-A) is at a fixed triangulation angle (φ) to the projection direction (O-O) of the laser device (2) and that is arranged at a fixed base distance (B) from the laser device (2), and is reflected by means of a planar light receiving element (6), whereupon signals output by the light receiving element (6) are used in a data processing device as a function of the triangulation angle (φ) and the base distance (B) to obtain measured values (z_{B}) of the profile (P) by means of geometric relationships, the values being stored as a profilogram (PG), the initial conditions of the solid body (1, 1a), including a distance from the laser device (2), a temporal variation in this distance and a light intensity distribution is determined at an initial instant (t₀), and thereafter there is determined from the initial conditions a detection instant (t_{flash}) for which signals output by the light receiving element (6) are selected in order to obtain the measured values (z_{B}) of the profile (P).

2. The method as claimed in claim 1, wherein a digital signal processor (DSP) is used to determine the detection instant (t_{flash}) for which signals output from the light receiving element (6) are selected in order to obtain the measured values (z_{B}) of the profile (P).

3. The method as claimed in claim 1, wherein the detection instant (t_{flash}) determined from the initial conditions is determined with the aid of the criterion of greatest possible temporal proximity to the initial instant (t₀).

4. The method as claimed in claim 1, wherein to determine the initial conditions of the solid body (1, 1a) at the initial instant (t₀) the signals output by the light receiving element (6) are used in order to obtain a pattern in the form of a binary coded mask, and the detection instant (t_{flash}) is fixed with the aid of the criterion of the recognition of this pattern.

5. The method as claimed in claim 4, wherein that in order to obtain and recognize the pattern, a light intensity distribution in the form of a transparency distribution, present on the solid body (1, 1a) at the initial instant (t₀) or at the detection instant (t_{flash}) is detected in a histogram and, using a lookup table (LT), is subjected to an image transformation, in the form of a threshold value operation including a highpass filtering.

6. The method as claimed in claim 4, wherein an alpha channel, in the form of a binary alpha channel, is used to obtain and recognize the binary coded mask pattern.

7. The method as claimed in claim 4, further comprising methods including filter operations in the form of intelligent image processing of the type including one or more of sharpening an image or producing a chrome effect, are used in order to obtain and recognize the pattern.

8. The method as claimed in claim 1, wherein the solid body (1, 1a) is a substantially rotationally symmetrical body, and undergoes a translatory and simultaneously rotating movement.

9. The method as claimed in claim 1, wherein the measured values (z_{B}) of the profile (P) of the body in the form of a vehicle wheel are obtained in combination with correction values (Ko) determined in accordance with the region of the surface of the solid body (1, 1a).

10. The method as claimed in claim 9, wherein the correction values (Ko) determined in accordance with the region of the surface of the solid body (1, 1a) are vectorial factors, determined as a function of a non-wearing wheel rim inside diameter (D_{fix}) of the rotationally symmetrical body.

11. The method as claimed in claim 1, wherein a number of profilograms (PG) are determined as component profilograms by using two light bands (3, 3a, 3b) projected on regions (D₁/M, D₂/M) lying on different sides (D₁, D₂, M) of the surface of the solid body (1, 1a), and an overall profilogram (GPG) is obtained therefrom.

12. The method as claimed in claim 11, wherein the light bands (3, 3a, 3b) are projected, simultaneously or with a time offset, onto one and the same measuring location, with reference to a position on a peripheral face (M) of the solid body (1, 1a), there being determined from the initial conditions for the two light bands (3, 3a, 3b) the detection instant (t_{flash}) for which signals output from the light receiving element (6) are selected in order to obtain the measured values (z_{B}) of the profile (P).

13. The method as claimed in claim 11, wherein the solid body (1, 1a) in the form of a vehicle wheel of substantially cylindrical or annular basic shape and the regions onto which the light bands (3, 3a, 3b) are projected lie on the two end faces (D₁, D₂) and on the peripheral face (M) of the cylinder or annulus.

14. The method as claimed in claim 1, wherein a determined profilogram (PG) and reference profilogram (PG) are referred to a fixed geometric basic size of long term invariability, including a nonwearing wheel rim inside diameter (D_{fix}).

15. The method as claimed in claim 1, wherein a device supplying digitized signals in the form of a trigger controlled CCD camera is used as light receiving element (6).

16. The method as claimed in claim 1, wherein the light band (3, 3a, 3b) has a width (b) in the range from 0.3 mm to 6.5 mm.

17. The method as claimed in claim 1, wherein the light band (3, 3a, 3b) has a length (LB) in the range from 50 mm to 750 mm.

18. The method as claimed in claim 1, wherein the light band (3, 3a, 3b) has a divergent angle (δ) that is greater than 45°.

19. The method as claimed in claim 1, wherein the triangulation angle (φ) has values in the range from 15° to 40° C.

20. The method as claimed in claim 1, wherein the frequency (f) at which the light (RL) reflected by the surface of the solid body (1, 1a) is detected by means of the light receiving element (6) lies in the range from 25 Hz to 100 kHz.

21. The method as claimed in claim 1, wherein a translatory movement speed (v) of the solid body is greater than 4.0 m/s.

22. The method as claimed in claim 1, wherein a mean working distance (L) of the laser device (2) or of the imaging device (5) from the region of the surface of the solid body (1, 1a) after which the light band (3, 3a, 3b) is projected lies in the range from 20 mm to 650 mm.

23. The method as claimed in claim 1, wherein the base distance (B) between the imaging device (5), in particular the midpoint of a focusing lens (4) of the imaging device (5), and the optical axis (O-O) of the laser device lies in the range from 30 mm to 450 mm.

24. The method as claimed in claim 1, wherein the determination of the detection instant (t_{flash}) for which signals output by the light receiving element (6) are selected in order to obtain the measured values (z_{B}) of the profile (P) is performed in a receiving loop (100) for whose implementation a hardware component is incorporated in a test stand (8) located on a track (9).

25. The method as claimed in claim 24, wherein the receiving loop (100) is implemented in a client of a client-server circuit with a spatially remote server, system start processes (95) including actuating traffic lights for a rail vehicle (10), activating a trigger for image triggering (106) or switching on the laser device (2) being set in motion by means of a request (90) from the server.

26. The method as claimed in claim 25, wherein the measured values (z_{B}), in the form of stored image data (108), are sent (113) to the server after the obtaining of the measured values (z_{B}) of the profile (P), after stopping (112) imaging.

27. The method as claimed in claim 24, wherein a laser distance sensor (101, 6) after signal conditioning (102) with the inclusion of analog-to-digital conversion is a signal (103) for the initial conditions from which there is determined by a signal evaluation (104) a detection instant (t_{flash}) at which a triggering pulse (105) is output to the light receiving element (6), as a result of which image triggering (106) is performed, an image matrix (107) being acquired and the acquired image being fed to a storage means (108).

28. The method as claimed in claim 24, wherein the receiving loop (100) includes as abort criteria condition checks (110, 111) that are connected to a timer or to a number of predetermined measurements.
